(19) United States
(12) Patent Application Publication
(10) Pub. No.: US 2010/0111035 A1
(43) Pub. Date: May 6, 2010

(54) LOCATION-BASED HANDOVERS FROM A MACROCELL TO A FEMTOCELL USING PERIODIC MEASUREMENT REPORTING

(76) Inventors: Suat Eskicioglu, Ottawa (CA); Cristian Demetrescu, Maidenhead (GB)

Correspondence Address: MARK W. SINCELL;Williams, Morgan & Amerson, P.C., Suite 1100, 10333 Richmond, Houston, TX, 77042, US

(21) Appl. No.: 12/265,136

(22) Filed: Nov. 5, 2008

(51) Int. Cl. H04W 36/00

(52) U.S. Cl. 370/331

(57) ABSTRACT

The present invention provides a method for implementation in user equipment that is configured to communicate with a wireless communication system that includes macro-cells femtocells. The method includes determining a distance between the user equipment and the femtocell(s). The method also includes periodically transmitting first measurement reports from the user equipment to the macrocell(s) at a selected time interval. The first measurement reports include information indicating the distance between the user equipment and the femtocell(s). The method also includes receiving a request to hand off from the macrocell(s) to the femtocell(s). The request is generated by a radio network controller based on the periodically transmitted measurement reports.

### CROSS REFERENCE TO RELATED APPLICATIONS

This application is related to U.S. patent application Ser. No. 12/265,089, filed on Nov. 5, 2008, entitled “LOCATION-BASED HANDOVERS FROM A MACROCELL TO A FEMTOCELL USING EVENT-TRIGGERED MEASUREMENT REPORT” inventors CRISTIAN DEMETRESCU and SUAT ESKICIOGLU. (2100.043000).

This application is related to U.S. patent application Ser. No. ______, filed on ______, entitled “LOCATION-BASED HANDOVERS FROM A MACROCELL TO A FEMTOCELL USING PERIODIC MEASUREMENT REPORTING” inventors CRISTIAN DEMETRESCU and SUAT ESKICIOGLU. (2100.043100).

This application is related to U.S. patent application Ser. No. ______, filed on ______, entitled “INTER-RADIO ACCESS TECHNOLOGY LOCATION-BASED HANDOVERS FROM A MACROCELL TO A FEMTOCELL” inventors CRISTIAN DEMETRESCU and SUAT ESKICIOGLU. (2100.043200).

This application is related to U.S. patent application Ser. No. ______, filed on ______, entitled “METHOD FOR ASSOCIATING A CLUSTER OF PREMIER FEMTOCELLS WITH USER EQUIPMENT” inventors CRISTIAN DEMETRESCU and SUAT ESKICIOGLU. (2100.043300).

This application is related to U.S. patent application Ser. No. ______, filed on ______, entitled “METHOD FOR ASSOCIATING A PREMIER FEMTOCELL WITH USER EQUIPMENT” inventors CRISTIAN DEMETRESCU and SUAT ESKICIOGLU. (2100.043400).

### BACKGROUND OF THE INVENTION

1. Field of the Invention

This invention relates generally to communication systems, and, more particularly, to wireless communication systems.

2. Description of the Related Art

Conventional wireless communication systems use a network of base stations to provide wireless connectivity to one or more mobile units. In some cases, the mobile units may initiate wireless communication with one or more base stations in the network, e.g., when the user of the mobile unit would like to initiate a voice or data call. Alternatively, the network may initiate the wireless communication link with the mobile unit. For example, in conventional hierarchical wireless communications, a server transmits voice and/or data destined for a target mobile unit to a central element such as a Radio Network Controller (RNC). The RNC may then transmit paging messages to the target mobile unit via one or more base stations or node-Bs. The target mobile unit may establish a wireless link to one or more of the base stations in response to receiving the page from the wireless communication system. A radio resource management function within the RNC receives the voice and/or data and coordinates the radio and time resources used by the set of base stations to transmit the information to the target mobile unit. The radio resource management function can perform fine grain control to allocate and release resources for broadcast transmission over a set of base stations.

A conventional base station provides wireless connectivity within a geographical region that is referred to as a cell, a macrocell, and/or a sector. Conventional base stations can transmit signals using a predetermined amount of available transmission power, which in some cases is approximately 35 W for a base station. The range of the macrocell is determined by numerous factors including the available transmission power, angular distribution of the available power, obstructions within the macrocell, environmental conditions, and the like. For example, the range of a macrocell can vary from as little as 300 m in a densely populated urban environment to as much as 10 km in a sparsely populated rural environment. The coverage area can also vary in time if any of these parameters changes.

One alternative to the conventional hierarchical network architecture is a distributed architecture including a network of access points, such as base station routers, that implement distributed communication network functionality. For example, each base station router may combine RNC and/or PDSN functions in a single entity that manages radio links between one or more mobile units and an outside network, such as the Internet. Base station routers wholly encapsulate the cellular access technology and may proxy functionality that utilizes core network element support to equivalent IP functions. For example, IP anchoring in a UMTS base station router may be offered through a Mobile IP Home Agent (HA) and the GGSN anchoring functions that the base station router proxies through equivalent Mobile IP signaling. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the separate RNC and PDSN entities in hierarchical networks may be reduced or removed.

At least in part because of the reduced cost and complexity of deploying a base station router, base station routers may be deployed in locations that are impractical for conventional base stations. For example, a base station router may be deployed in a residence or building to provide wireless connectivity to the occupants of the residents of the building. Base station routers deployed in a residence are typically referred to as home base station routers or femtocells because they are intended to provide wireless connectivity to a much smaller area (e.g., a femtocell) that encompasses a residence. Femtocells have a much smaller power output than conventional base stations that are used to provide coverage to macrocells. For example, a typical femtocell has a transmission power on the order of 10 mW. Consequently, the range of a typical femtocell is much smaller than the range of a macrocell. For example, a typical range of a femtocell is about 100 m. Clusters of femtocells may also be deployed to provide coverage to larger areas and/or to more users.

Femtocells are expected to be deployed in conjunction with a macro-cellular network in an overlay configuration. For example, a macro-cellular network may be used to provide wireless connectivity to a neighborhood that includes numerous residences. Any mobile unit traveling through the neighborhood or located in one of the residences can access the wireless communication system using the macro-cellular network. Individual femtocells can be deployed in one or more of the residences to provide overlay coverage within (or near) the residence. Clusters of femtocells can also be deployed in one or more of the buildings to provide overlay coverage within (or near) the building. In either case, there will be a one-to-many relationship between the macrocells and the femtocells within the coverage area. However, user equipment will typically only be authorized to camp on selected femtocells. For example, user equipment operated by an individual user can be authorized to camp on femtocells that were installed by the user in their residence. For another example, user equipment operated by employees can be authorized to camp on femtocells in a femtocell cluster installed by a business.

As the user moves throughout the geographic areas served by the macrocells and the femtocells, the user equipment can be handed off between the macrocells and/or the femtocells. Conventional communication systems use radio conditions and/or the availability of radio resources to determine when to hand off user equipment. For example, channel qualities and/or signal strengths can be measured using signals transmitted between the user equipment and the macrocells and/or the femtocells. The conventional system hands off the user equipment from a macrocell to a femtocell when the channel qualities and/or signal strengths for signals transmitted by the macrocell are poor relative to the measured channel qualities and/or signal strengths for the femtocell. However, the conventional handoff criteria do not discriminate between generic femtocells, femtocells associated with particular user equipment, and macrocells. Consequently, user equipment may not be handed off to authorized home and/or business femtocells as long as the radio conditions in the macro-cellular network are sufficiently high quality, even if the user is inside the home or business covered by the associated femtocell. For example, when the femtocells are on a different frequency than the macrocells, radio conditions in the macro-cellular network may remain sufficiently high quality to prevent substantially all handovers to the femtocell, e.g., when the femtocell is deployed at the center of a macrocell's coverage area.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for implementation in user equipment that is configured to communicate with a wireless communication system that includes macro-cells and femtocells. The method includes determining a distance between the user equipment and the femtocell(s). The method also includes periodically transmitting first measurement reports from the user equipment to the macrocell(s) at a selected time interval. The first measurement reports include information indicating the distance between the user equipment and the femtocell(s). The method also includes receiving a request to hand off from the macrocell(s) to the femtocell(s). The request is generated by a radio network controller based on the periodically transmitted measurement reports.

In another embodiment, a method is provided for implementation in a radio network controller that is configured for deployment in a wireless communication system that includes macrocells and femtocells. The method includes periodically receiving first measurement reports from user equipment at a selected time interval. The first measurement reports include information indicating a distance between the user equipment and one or more of the femtocells. The method also includes generating a request to hand off the user equipment from one or more of the macrocells to one or more of the femtocells. The request is generated based on the periodically transmitted measurement reports and provided to the user equipment via one or more of the macrocells.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a wireless communication system;

FIG. 2 conceptually illustrates a second exemplary embodiment of a wireless communication system;

FIG. 3 conceptually illustrates a first exemplary embodiment of a method of handing off user equipment between a macrocell and a femtocell that operate on the same frequency; and

FIG. 4 conceptually illustrates a second exemplary embodiment of a method of handing off user equipment between a macrocell and a femtocell that operate on different frequencies.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

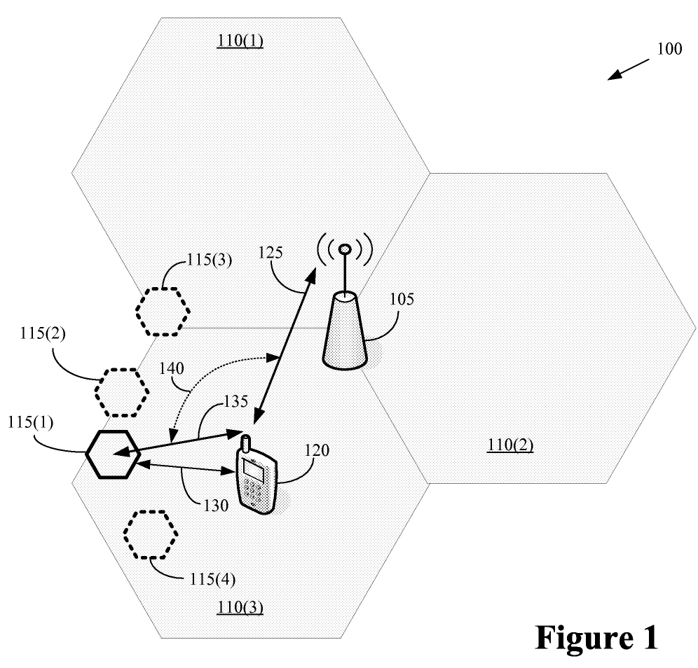

FIG. 1 conceptually illustrates a first exemplary embodiment of a wireless communication system 100. In the illustrated embodiment, a base station 105 provides wireless connectivity to a plurality of macro-cells 110(1-3). Although the indices (1-3) can be used to identify individual macro cells 110(1) or subsets thereof, these indices may be dropped when referring collectively to the macro-cells 110. This convention may be applied to other elements depicted in the drawings and referred to using an identifying numeral and one or more distinguishing indices. The macro-cells 110 shown in FIG. 1 correspond to different sectors associated with the base station 105. For example, the base station 105 may include three antennas (or three groups of antennas) that provide wireless connectivity to three sectors associated with the three macro-cells 110. However, persons of ordinary skill in the art having benefit of the present disclosure should appreciate that alternative embodiments may use a different base station 105 to provide wireless connectivity to each macro-cell 110. Moreover, the wireless communication system 100 may include any number of macro-cells 110 and/or base stations 105. In alternative embodiments, the base stations 105 may be a part of a hierarchical network or a distributed network.

The wireless communication system 100 also includes an overlay network of femtocells 115. For example, the femtocells 115 may be installed in businesses and/or residences by individual users, companies, or other entities. In the interest of clarity, only four femtocells 115 are depicted in FIG. 1. However, persons of ordinary skill in the art having benefit of the present disclosure should appreciate that the wireless communication system 100 may include any number of femtocells 115 distributed throughout the wireless communication system 100. User equipment, such as the mobile unit 120 shown in FIG. 1, can be associated with one or more of the femtocells 115. For example, a user that has installed the femtocell 115(1) in a residence can configure the user equipment 120 so that the user equipment 120 recognizes the femtocell 115(1) as its premier femtocell. The user equipment 120 may therefore preferentially hand off to the premier femtocell 115(1) when the user equipment 120 approaches the premier femtocell 115(1). In one embodiment, the femtocell 115(1) may be part of a femtocell cluster (not shown in FIG. 1).

The femtocell 115(1) is a premier femtocell for the user equipment 120. As used herein, the term “premier femtocell” refers to a femtocell that has been associated with the user equipment 120 so that the user equipment 120 is authorized to preferentially access the premier femtocell. Exemplary situations in which a premier femtocell can be defined include femtocell installed by users in their homes, femtocells (or clusters of femtocells) installed in a place of business, and the like. Mobility information related to the premier femtocell 115(1) may be stored in the user equipment 120 and in network entities such as the base station 105 and/or a radio network controller (not shown in FIG. 1) that is communicatively coupled to the base station 105. Exemplary mobility information includes, but is not limited to, information identifying the premier femtocell 115(1), information indicating a location of the premier femtocell 115(1), information indicating a frequency (or frequencies) used by the premier femtocell 115(1) for communication over the air interface, and the like.

In the illustrated embodiment, the user equipment 120 has an existing wireless communication link 125 with the base station 105, i.e., the user equipment 120 is in communication with the macrocell 110(3) via one or more antennas supported by the base station 105. The user equipment 120 is configured to periodically determine a distance 130 between the user equipment 120 and its premier femtocell 115(1) and report the distance 130 to the wireless communication system 100. For example, a radio network controller can transmit a Measurement Control message that instructs the user equipment 120 to periodically measure and report the distance 130 to the radio network controller and radio conditions like CPICH Ec/No and CPICH RSCP of the neighbor cells including femto cells. The Measurement Control message may include information indicating the time interval for the periodic measurements or, alternatively, the time interval may be preconfigured in the user equipment 120.

The wireless communication system 100 may then determine whether the distance 130 is less than a selected distance threshold value. If the distance 130 is less than the selected distance threshold value, the wireless communication system 100 may initiate a handoff of the user equipment 120 from the base station 105 and corresponding macrocell 110(3) to the femtocell 115(1). A wireless communication link 135 between the user equipment 120 and the premier femtocell 115(1) may be created and the user equipment 120 may be handed off (as indicated by the dashed line 140) to the premier femtocell 115(1). In one embodiment, the wireless communication system 100 may also use additional criteria, such as measures of the quality of the wireless communication link 135 (e.g. CPICH EcNo and CPICH RSCP), to determine when to perform a handoff. In the illustrated embodiment, the location-based handoff is only applied to premier femtocells 115(1) associated with the user equipment 120. Accordingly, the user equipment 120 may be preferentially handed off to its premier femtocell 115(1) even though the air interface 125 to the macrocell 110(3) may be providing sufficiently high quality channel conditions or even channel conditions that are superior to the channel conditions supported by the air interface 135.

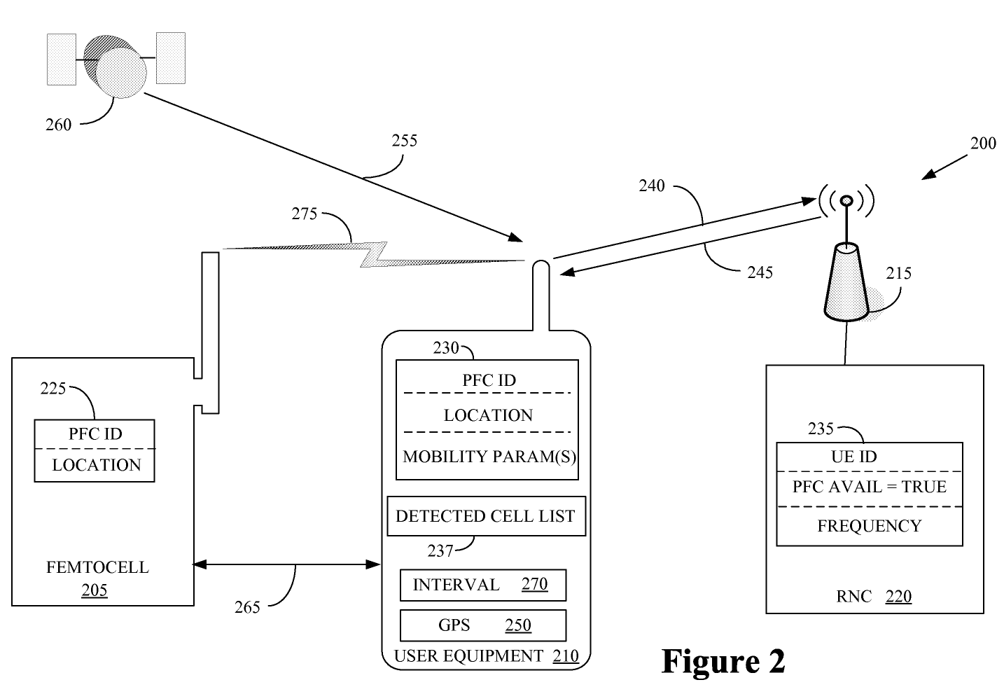

FIG. 2 conceptually illustrates a second exemplary embodiment of a wireless communication system 200. In the illustrated embodiment, the wireless communication system 200 includes a femtocell 205, user equipment 210, a base station 215, and a radio network controller (RNC) 220. Persons of ordinary skill in the art having benefit of the present disclosure should appreciate that the wireless communication system 200 may include other elements that are not depicted in FIG. 2 to avoid unnecessarily obscuring the discussion. The femtocell 205 is a premier femtocell for the user equipment 210. In the illustrated embodiment, the femtocell 205 stores information 225 including an identifier and information indicating the location of the femtocell 205. The location information may be determined using numerous different techniques, including Global Positioning System (GPS) functionality incorporated into the femtocell 205 or manual configuration of the femtocell 205 by a user or a service provider.

Neighboring cell lists are typically maintained at the radio network controller 220 so that it knows which cells reported by the user equipment 210 should be considered for potential handovers. The radio network controller 220 may therefore ignore measurement reports associated with cells that are not listed in the neighboring cell list. Including the femtocell 205 in a neighboring cell list may be too cumbersome and unmanageable for the service operators due in part to the high volume of femtocells 205 that may be deployed in a network. Therefore, in the illustrated embodiment, the femtocell 205 is not included in a neighboring cell list associated with the macrocell corresponding to the base station 215. However, user equipment 210 can still measure distance and radio qualities of femtocell 205 by including the femtocell 205 in its detected set. Periodic measurement reports transmitted by the user equipment may include the PSC of the femtocell 205 as well as other information that enables the radio network controller 220 to uniquely identify the femtocell 205, which is then considered when determining whether to handoff the user equipment 210.

The user equipment 210 has been configured so that it recognizes the femtocell 205 as its premier femtocell. In the illustrated embodiment, the user equipment 210 stores the identity of the premier femtocell 205, the location of the premier femtocell 205, and any other mobility parameters associated with the premier femtocell 205. Exemplary mobility parameters include, but are not limited to, primary scrambling codes (PSC), an international mobile subscriber identity, a UTRAN Radio Network Temporary Identifier (U-RNTI), and the like. In the illustrated embodiment, the user equipment 210 defines a local variable, e.g. a data structure 230, to store the femtocell information relevant to mobility. In the illustrated embodiment, the user equipment 210 stores the current cell information (relevant to mobility) and the location information (which may be provided by the femtocell 205 in a RRC Connection Setup message) into the PremierFemtoCell local data structure 230 when a PremierFemtoCellAvailable Boolean value in the setup message from the femtocell 205 is set to TRUE.

The radio network controller 220 maintains a context database 235 that stores contact information associated with the user equipment 210, as well as other user equipment served by macro-cells that are connected to the radio network controller 220. In the illustrated embodiment, the radio network controller 220 stores the information associated with the user equipment 210 and information indicating that the user equipment 210 is associated with a premier femtocell in the RRC context 235 for the user equipment 210. For example, the context 235 for the user equipment 210 may include an identifier, a Boolean variable indicating that a premier femtocell is available, a parameter indicating the frequency used by the premier femtocell 205, and the location of the femtocell 205. Once the context 235 for the user equipment 215 has been configured, the radio network controller 220 knows that the user equipment 210 is associated with a premier femtocell. Although the user equipment 210 has been depicted as being associated with a single premier femtocell, persons of ordinary skill in the art having benefit of the present disclosure should appreciate that in alternative embodiments the user equipment 210 may be associated with more than one premier femtocell.

In the illustrated embodiment, the user equipment 210 is initially served by the base station 215 over a wireless communication link including an uplink 240 and a downlink 245. The user equipment 210 is also aware of its location. In the illustrated embodiment, the user equipment 210 includes Global Positioning System (GPS) functionality 250 to determine its location using signals 255 provided by a network of GPS satellites 260 (only one shown in FIG. 2). Alternatively, the user equipment 210 can be made aware of its location using information provided by the base station 215 over the downlink 245. This approach can be referred to as an assisted-GPS technique. The user equipment 210 can therefore use the stored location of the premier femtocell 205 to determine how far away the premier femtocell 205 is from the user equipment 210.

The radio network controller 220 can configure the user equipment 210 for periodic location measurement and/or reporting. In the illustrated embodiment, the user equipment 210 is configured to periodically determine a distance 265 between the femtocell 205 and the user equipment 210 by comparing its current location to the stored location of the femtocell 205. The time interval 270 for the periodic measurement/reporting is stored in the user equipment 210. The time interval 270 may be preconfigured, may be manually entered by a user, and/or may be provided to the user equipment 210 by the radio network controller 220 as part of the configuration process. The radio network controller 220 may then use the periodically reported values of the distance 265 to determine whether to hand off the user equipment 210 to the femtocell 205.

The radio network controller 220 may also use other information, such as channel conditions, to determine whether to hand off the user equipment 210 to the femtocell 205. In one embodiment, the user equipment 210 periodically measures channel conditions associated with an air interface 275 between the user equipment 210 and the femtocell 205. Values of the measured channel conditions may then be reported to the radio network controller 220 with the periodic location reports. Alternatively, the channel conditions may be measured and the values of the measured channel conditions reported to the radio network controller 220 in response to requests provided by the radio network controller 220. For example, if the femtocell 205 and the base station 215 use different frequencies for communication over the air interfaces 240, 245, 275, the radio network controller 220 may instruct the user equipment 210 to perform and report the channel condition measurements when the radio network controller 220 determines that the distance 265 reported periodically by the user equipment 210 has fallen below a threshold value. The user equipment 210 may perform the channel condition measurements by entering the compressed mode, as instructed by the radio network controller 220.

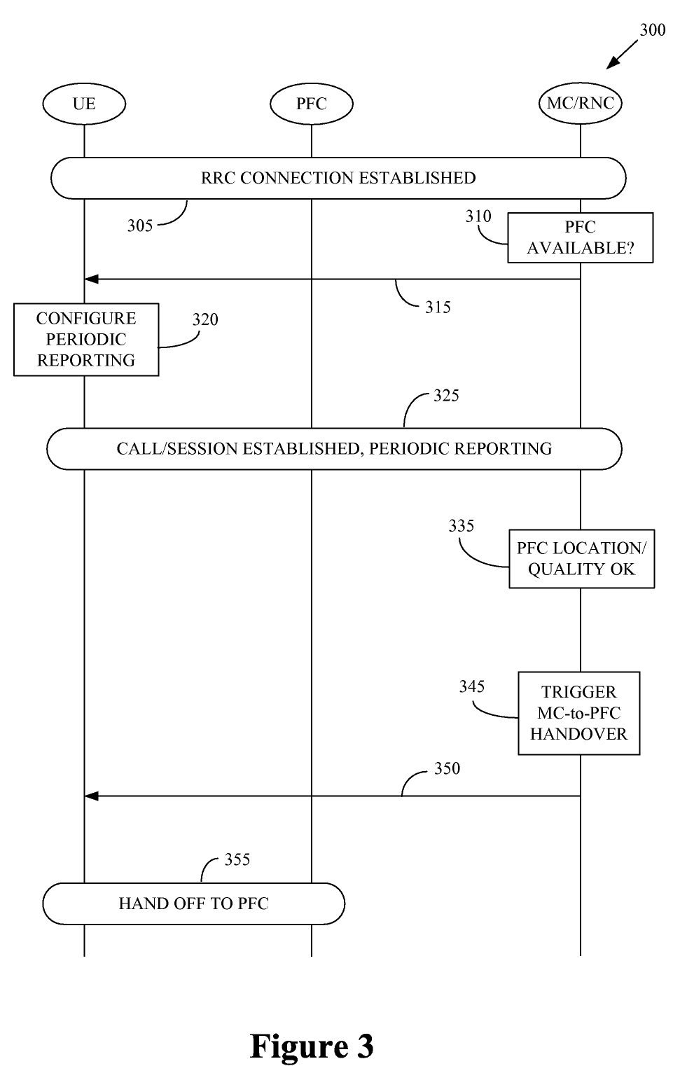

FIG. 3 conceptually illustrates a first exemplary embodiment of a method 300 of handing off user equipment (UE) from a macrocell (MC/RNC) to a premier femtocell (PFC). In the first exemplary embodiment, the macrocell and the premier femtocell use the same frequencies for communications over the air interface. The first exemplary embodiment therefore depicts an intra-frequency handoff procedure. Initially, an RRC connection is established (at 305) between the user equipment and the macrocell. The macrocell then determines (at 310) whether the user equipment has an associated premier femtocell. For example, the macrocell may examine the context associated with the user equipment to determine (at 310) whether the variable PremierFemtoCellAvailable is set to TRUE. In the illustrated embodiment, the user equipment does have an associated premier femtocell, so the macrocell also determines (at 310) the frequency used by the premier femtocell to communicate with the user equipment, which in the first exemplary embodiment is the same as the frequency of the macrocell.

The macrocell then transmits (at 315) a measurement control message that includes information that is used to configure periodic reporting of the distance between the user equipment and the premier femtocell. The user equipment receives this information and configures (at 320) the periodic location/distance reporting. For example, the user equipment may receive (at 320) information indicating a time interval that should be used to periodically measure and report the distance between the user equipment and the premier femtocell. Alternatively, the time interval may be preconfigured or manually entered by a user. The user equipment may also be configured (at 320) to perform periodic measurements of channel quality information (e.g., CPICH Ec/Io and/or CPICH RSCP) associated with the air interface between the user equipment and the premier femtocell. Configuration (at 320) of the user equipment may also include defining the fields and/or parameters of messages that are periodically transmitted to the macrocell. For example, the user equipment may be configured (at 320) to transmit Measurement Reports that include information indicating the distance between the user equipment in the femtocell, channel quality information, and the like.

A call and/or session may then be established (at 325) between the user equipment and the macrocell. At this point in the process, the call between the user equipment and the macrocell can proceed. Since the user equipment has been configured (at 320) for periodic reporting of the location information, the user equipment continues (concurrently with other call processes) to compare its location to the location of its premier femtocell and, in some cases, to monitor the channel qualities associated with the air interface to the femtocell. For example, the user equipment can compare (at 335) the current location of the user equipment to a location of the premier femtocell to determine the distance:

UE_PremierFemto_distance=UE_coordinates−premierFemto_coordinates

The user equipment can also use the pilot channel (CPICH) transmitted by the premier femtocell to assess the quality of the channel based on either signal-to-noise ratios or received signal channel powers (RSCP). The user equipment periodically reports the results of these measurements to the macrocell by transmitting messages at the configured time interval. The measurement report may also include other mobility information including, but not limited to, primary scrambling codes, timing and/or offset information, CPICH Ec/No, CPICH RSCP, and the like.

The radio network controller may use the reported location/distance information to determine (at 335) that the distance between the user equipment and the premier femtocell has fallen below a threshold value. For example, the radio network controller can compare (at 335) the distance to the threshold and a handoff procedure can be triggered (at 345) if:

UE_PremierFemto_distance<MacroToFemtoDistanceThreshold

In one embodiment, the radio network controller may also assess (at 335) whether the quality of the channel between the user equipment and the femtocell is sufficiently high to support communication over the air interface. For example, an intra-frequency handover from the macrocell to the femtocell can then be triggered (at 345) if:
CPICH Ec/No>EcNoThresholdIntraFreqPeriodic
   and/or
CPICH RSCP>RscpThresholdIntraFreqPeriodic.
   Thus, handover of the user equipment is triggered by proximity of the user equipment to the premier femtocell as long as the quality of the channel to the femtocell is sufficiently high. In this procedure, the channel quality associated with communication between user equipment and the macrocell does not need to be considered when deciding whether to handoff the user equipment to the premier femtocell.

Once the handoff has been triggered (at 345), the radio network controller can transmit (at 350) one or more messages to initiate handover of the user equipment from the macrocell to the femtocell. In one embodiment, the radio network controller can send (at 350) the primary scrambling code (PSC) and international mobile subscriber identity (IMSI) of the user equipment to a BSG femtocell gateway using an Iu Relocation Request. The gateway maps the femtocell primary scrambling code and the user equipment's IMSI to an identifier of the premier femtocell. The gateway can then send an Iu Relocation Command to the premier femtocell and the radio network controller sends (at 350) an Iu Reconfiguration Request to the user equipment. The reconfiguration request includes details identifying the premier femtocell so that the user equipment can establish communications with the premier femtocell. The user equipment then hands off (at 355) from the macrocell to the premier femtocell.

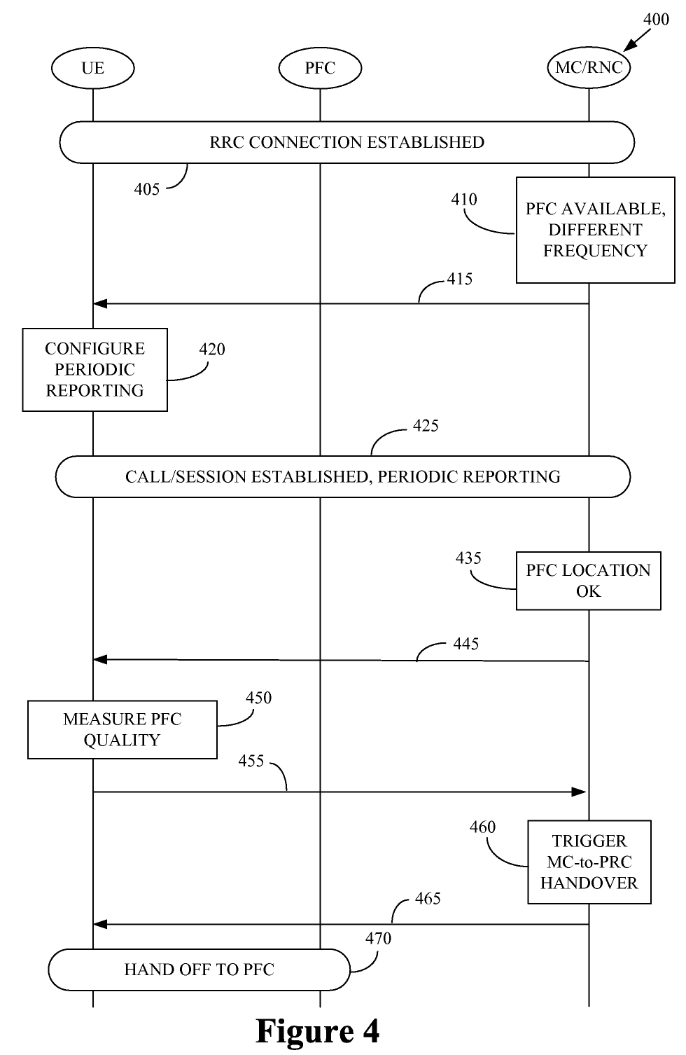

FIG. 4 conceptually illustrates a second exemplary embodiment of a method 400 of handing off user equipment (UE) from a macrocell (MC/RNC) to a premier femtocell (PFC). In the second exemplary embodiment, the macrocell and the premier femtocell use different frequencies for communications over the air interface. The second exemplary embodiment therefore depicts an inter-frequency handoff procedure. Initially, an RRC connection is established (at 405) between the user equipment and the macrocell. The macrocell then determines (at 410) whether the user equipment has an associated premier femtocell. For example, the macrocell may examine the context associated with the user equipment to determine (at 410) whether the variable PremierFemtoCellAvailable is set to TRUE. In the illustrated embodiment, the user equipment does have an associated premier femtocell, so the macrocell also determines (at 410) the frequency used by the premier femtocell to communicate with the user equipment, which in the second exemplary embodiment is different than the frequency of the macrocell.

The macrocell then transmits (at 415) a measurement control message that includes information that is used to configure periodic reporting of the distance between the user equipment and the premier femtocell. The user equipment receives this information and configures (at 420) the periodic location/distance reporting. For example, the user equipment may receive (at 420) information indicating a time interval that should be used to periodically measure and report the distance between the user equipment and the premier femtocell. Alternatively, the time interval may be preconfigured or manually entered by a user. Configuration (at 420) of the user equipment may also include defining the fields and/or parameters of messages that are periodically transmitted to the macrocell. For example, the user equipment may be configured (at 420) to transmit Measurement Reports that include information indicating the distance between the user equipment in the femtocell.

A call and/or session may then be established (at 425) between the user equipment and the macrocell. At this point in the process, the call between the user equipment and the macrocell can proceed. Since the user equipment has been configured (at 420) for periodic reporting of the location information, the user equipment continues to compare (concurrently with other call processes) its location to the location of its premier femtocell. For example, the user equipment can compare (at 435) the current location of the user equipment to a location of the premier femtocell to determine the distance:

UE_PremierFemto_distance=UE_coordinates−premierFemto_coordinates.

The user equipment periodically reports the measured distance to the macrocell/radio network controller by transmitting messages, such as Measurement Report messages, at the configured time interval.

In the illustrated embodiment, the radio network controller can determined (at 435) whether the distance between the user equipment and the premier femtocell is small enough to trigger a handoff from the macrocell to the premier femtocell. For example, the periodically reported distance can be compared to a threshold value and a handoff procedure may be desirable if:

UE_PremierFemto_distance<MacroToFemtoDistanceThreshold

When the distance criterion is satisfied, the macrocell transmits (at 445) a message indicating that the user equipment should operate in the inter-frequency compressed mode. In one embodiment, the Measurement Control message that activates the inter-frequency compressed mode is only used for the premier femtocells allowed by the user equipment.

When the user equipment receives this message, the user equipment enters (at 450) the compressed mode and performs various channel quality measurements, e.g., using a pilot channel transmitted by the femtocell. For example, the user equipment can use the pilot channel (CPICH) transmitted by the premier femtocell to assess the quality of the channel based on either signal-to-noise ratios or received signal channel powers (RSCP). The user equipment then reports the results of these measurements to the macrocell by transmitting (at 455) a measurement report to the macrocell/radio network controller. The measurement report may also include other mobility information including, but not limited to, primary scrambling codes, timing and/or offset information, CPICH Ec/No, CPICH RSCP, and the like.

The radio network controller uses the inter-frequency compressed mode measurements to determine (at 460) whether the quality of the channel between the user equipment and the femtocell is sufficiently high to support communication over the air interface. For example, the radio network controller can use the information transmitted (at 455) by the user equipment to assess the quality of the channel based on signal-to-noise ratios and/or received signal channel powers (RSCP). The inter-frequency handover from the macrocell to the femtocell can then be triggered (at 460) if:
CPICH Ec/No>EcNoThresholdHHO
   and/or
CPICH RSCP>RscpThresholdHHO.
   Thus, inter-frequency handover of the user equipment is triggered (at 460) by proximity of the user equipment to the premier femtocell as long as the quality of the channel to the femtocell is sufficiently high. In this procedure, the channel quality associated with communication between user equipment and the macrocell does not need to be considered when deciding whether to handoff the user equipment to the premier femtocell.

The radio network controller then transmits (at 465) a message requesting the inter-frequency handover of the user equipment from the macrocell to the femtocell. In one embodiment, the radio network controller can send the primary scrambling code and international mobile subscriber identity (IMSI) of the user equipment to a BSG femtocell gateway using an Iu Relocation Request. The gateway maps the femtocell primary scrambling code and the user equipment's IMSI to an identifier of the premier femtocell. The gateway can then send an Iu Relocation Command to the premier femtocell and the radio network controller sends (at 465) an Iu Reconfiguration Request to the user equipment. The reconfiguration request includes details identifying the premier femtocell so that the user equipment can establish communications with the premier femtocell. The user equipment then hands off (at 470) from the macrocell to the premier femtocell.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for implementation in user equipment that is configured to communicate with a wireless communication system that comprises at least one macro-cell and at least one femtocell, the method comprising:
determining, at said user equipment, a distance between said user equipment and said at least one femtocell;
periodically transmitting, from said user equipment to said at least one macrocell, first measurement reports at a selected time interval, wherein said first measurement reports comprise information indicating the distance between said user equipment and said at least one femtocell; and
receiving, from said at least one macrocell, a request to hand off from said at least one macrocell to said at least one femtocell, the request being generated by a radio network controller based on the periodically transmitted measurement reports.

2. The method of claim 1, comprising receiving, from said at least one macrocell, a measurement control message including information requesting periodic transmission of the first measurement reports and wherein periodically transmitting the first measurement reports comprises periodically transmitting the first measurement reports in response to receiving the measurement control message.

3. The method of claim 2, wherein receiving the measurement control message comprises receiving a measurement control message including information indicating the selected time interval for periodically transmitting the first measurement reports.

4. The method of claim 2, wherein receiving the measurement control message comprises receiving the measurement control message in response to the radio network controller determining that said user equipment is associated with at least one premier femtocell.

5. The method of claim 4, wherein determining the distance comprises determining a distance between said at least one macrocell and said at least one premier femtocell associated with said user equipment.

6. The method of claim 1, wherein said at least one femtocell and said at least one macrocell use the same frequency or frequencies for transmission, and wherein receiving the request to hand off from said at least one macrocell to said at least one femtocell comprises receiving the request in response to the radio network controller determining that the distance is less than a distance threshold.

7. The method of claim 6, comprising periodically measuring at least one of a signal-to-noise ratio or a received signal channel power using a pilot channel transmitted by said at least one femtocell.

8. The method of claim 7, wherein periodically transmitting the first measurement reports comprises periodically transmitting first measurement reports including information indicating measured values of said at least one of the signal-to-noise ratio or the received signal channel power.

9. The method of claim 8, wherein receiving the request to hand off from said at least one macrocell to said at least one femtocell comprises receiving the request in response to the radio network controller determining that said at least one of the signal-to-noise ratio or the received signal channel power is more than a corresponding threshold value of said signal-to-noise ratio or received signal channel power.

10. The method of claim 1, wherein said at least one femtocell and said at least one macrocell use a different frequency or frequencies for transmission, and wherein receiving the request to hand off from said at least one macrocell to said at least one femtocell comprises receiving instructions to enter an inter-frequency compressed mode in response to the radio network controller determining that the distance is less than a distance threshold.

11. The method of claim 10, comprising measuring, in the compressed mode, at least one of a signal-to-noise ratio or a received signal channel power using a pilot channel transmitted by said at least one femtocell.

12. The method of claim 11, comprising transmitting at least one second measurement reports comprising information indicating at least one measured value of the signal-to-noise ratio or the received signal channel power.

13. The method of claim 12, wherein receiving the request to hand off from said at least one macrocell to said at least one femtocell comprises receiving the request in response to the radio network controller determining that said at least one measured value of the signal-to-noise ratio or the received signal channel power is more than a corresponding threshold value of said signal-to-noise ratio or received signal channel power.

14. The method of claim in 1, comprising handing off said user equipment from said at least one macrocell to said at least one femtocell in response to receiving the request to hand off.

15. A method for implementation in a radio network controller that is configured for deployment in a wireless communication system that comprises at least one macro-cell and at least one femtocell, the method comprising:
periodically receiving, from user equipment in communication with said at least one macrocell, first measurement reports at a selected time interval, wherein said first measurement reports comprise information indicating a distance between said user equipment and said at least one femtocell;
generating a request to hand off said user equipment from said at least one macrocell to said at least one femtocell, the request being generated based on the periodically transmitted measurement reports; and
providing the request to hand off said user equipment to said at least one macrocell for transmission to said user equipment.

16. The method of claim 15, comprising providing, to said at least one macrocell for transmission to said user equipment, information requesting periodic transmission of the first measurement reports.

17. The method of claim 16, wherein providing the information requesting the periodic transmissions comprises providing information indicating the selected time interval for periodically transmitting the first measurement reports.

18. The method of claim 16, wherein providing the information requesting the periodic transmissions comprises providing the information requesting the periodic transmissions of distance between the said user equipment and said premier femtocell in response to the radio network controller determining that said user equipment is associated with at least one premier femtocell.

19. The method of claim 15, wherein said at least one femtocell and said at least one macrocell use the same frequency or frequencies for transmission, and wherein providing the request to hand off from said at least one macrocell to said at least one femtocell comprises providing the request in response to determining, at the radio network controller, that the distance is less than a distance threshold.

20. The method of claim 19, wherein periodically receiving the first measurement reports comprises periodically receiving first measurement reports including information indicating measured values of at least one of a signal-to-noise ratio or a received signal channel power measured by said user equipment using a pilot channel transmitted by said at least one femtocell.

21. The method of claim 20, wherein providing the request to hand off from said at least one macrocell to said at least one femtocell comprises providing the request in response to determining, at the radio network controller, that said at least one of the signal-to-noise ratio or the received signal channel power is more than a corresponding threshold value of said signal-to-noise ratio or received signal channel power.

22. The method of claim 15, wherein said at least one femtocell and said at least one macrocell use a different frequency or frequencies for transmission, and wherein providing the request to hand off from said at least one macrocell to said at least one femtocell comprises providing instructions to enter a compressed mode in response to determining, at the radio network controller, that the distance is less than a distance threshold.

23. The method of claim 22, comprising receiving at least one second measurement reports comprising information indicating at least one measured value of a signal-to-noise ratio or a received signal channel power measured by said user equipment using a pilot channel transmitted by said at least one femtocell.

24. The method of claim 23, wherein providing the request to hand off from said at least one macrocell to said at least one femtocell comprises providing the request in response to determining, at the radio network controller, that said at least one measured value of the signal-to-noise ratio or the received signal channel power is more than a corresponding threshold value of said signal-to-noise ratio or received signal channel power.

25. The method of claim 15, comprising handing off said user equipment from said at least one macrocell to said at least one femtocell by uniquely identifying the premier femto cell using mobile IMSI and femto scrambling code.
